(19) United States
(12) Patent Application Publication
(10) Pub. No.: US 2016/0138245 A1
(43) Pub. Date: May 19, 2016

(54) HYBRID WORK MACHINE AND METHOD OF CONTROLLING HYBRID WORK MACHINE

(71) Applicant: KOMATSU LTD., Tokyo (JP)

(72) Inventor: Atsushi MOKI, Fujisawa-shi (JP)

(21) Appl. No.: 14/899,300

(22) PCT Filed: May 26, 2014
(86) PCT No.: PCT/JP2014/063869

§ 371 Date: Dec. 17, 2015

(30) Foreign Application Priority Data
Jun. 19, 2013 (JP) 2013-128736

(51) Int. Cl. E02F 9/20; H02K 7/18

(52) U.S. Cl. CPC E02F 9/2075; H02K 7/1815; Y10S 903/906

(57) ABSTRACT

A hybrid work machine includes: a generator motor that is connected to a drive shaft of an internal combustion engine; a storage battery that stores at least power generated by the generator motor; a motor that is driven by at least one of the power generated by the generator motor and power stored in the storage battery; a booster that includes two bridge circuits each having a plurality of switching elements and is provided between the generator motor as well as the motor and the storage battery; and a booster control unit that sets a phase difference between voltages output by the bridge circuits to be zero during standby in which servo control on both the generator motor and the motor is turned off.

### FIELD

The present invention relates to a hybrid work machine including an internal combustion engine, a generator motor, a storage battery, and a motor driven by power from at least one of the generator motor and the storage battery, and a method of controlling the hybrid work machine.

### BACKGROUND

There has been provided a hybrid work machine that drives a generator motor by an engine, drives a motor with power generated by the generator motor and operates work equipment or the like. The hybrid work machine is provided with a booster between the generator motor and motor and a storage battery such as a capacitor or battery, for example, so that power is interchanged between the generator motor and motor and the storage battery through the booster. Patent Literature 1 discloses a technique that transforms voltage of a battery by a DC-DC converter and supplies it to an inverter driving a motor.

### CITATION LIST

### Patent Literature

Patent Literature 1: Japanese Patent Application Laid-open No. 2005-168167

### SUMMARY

### Technical Problem

One state of the hybrid work machine is a state in which the generator motor does not generate power or perform power running while at the same time the motor is stopped, namely a state in which servo control on both the generator motor and the motor is turned off. When there is a loss in the booster in this situation, the power in the storage battery is consumed by the booster, causing the voltage of the storage battery to drop. The storage battery is then charged by causing the generator motor to generate power by the engine, which at this time consumes power to charge the storage battery and thus consumes fuel to exert that power. Accordingly, the hybrid work machine equipped with the booster is required to suppress the loss in the booster in the state in which the servo control on both the generator motor and the motor is turned off. Patent Literature 1 does not include description or suggestion pertaining to such point and thus has room for improvement

An object of the present invention is to suppress the loss in the booster of the hybrid work machine while the servo control on both the generator motor and the motor is turned off.

### Solution to Problem

According to the present invention, there is provided a hybrid work machine comprising: a generator motor that is connected to a drive shaft of an internal combustion engine; a storage battery that stores at least power generated by the generator motor; a motor that is driven by at least one of the power generated by the generator motor and power stored in the storage battery; a booster that includes two bridge circuits each having a plurality of switching elements and is provided between the generator motor as well as the motor and the storage battery; and a booster control unit that sets a phase difference between voltages output by the bridge circuits to be zero during standby in which servo control on both the generator motor and the motor is turned off.

In the present invention, it is preferable that the two bridge circuits are coupled to each other by a transformer, the booster control unit controls the phase difference such that a difference between a voltage value output from the booster and a predetermined threshold equals zero when a K-fold value of voltage output from the storage battery is higher than or equal to the predetermined threshold during the standby, and K is a boost ratio of the transformer.

According to the present invention, there is provided a hybrid work machine comprising: a generator motor that is connected to an output shaft of an internal combustion engine; a storage battery that stores power generated by the generator motor; a motor that is driven by at least one of the power generated by the generator motor and power stored in the storage battery; a booster that is a transformer coupled DC-DC converter in which two bridge circuits each having a plurality of switching elements are coupled to each other by the transformer, and is provided between the generator motor as well as the motor and the storage battery; and a booster control unit that sets a phase difference between voltages output by the bridge circuits to be zero during standby in which servo control on both the generator motor and the motor is turned off, and controls the phase difference such that a difference between a voltage value output from the booster and a predetermined threshold equals zero when a K-fold value of voltage output from the storage battery is higher than or equal to the predetermined threshold during the standby, wherein K is a boost ratio of the transformer coupling the two bridge circuits included in the booster.

According to the present invention, there is provided a method of controlling a hybrid work machine including a generator motor that is connected to a drive shaft of an internal combustion engine, a storage battery that stores at least power generated by the generator motor, a motor that is driven by at least one of the power generated by the generator motor and power stored in the storage battery, and a booster that includes two bridge circuits each having a plurality of switching elements and is provided between the generator motor as well as the motor and the storage battery, the method comprising: determining a state of the generator motor and the motor; and setting a phase difference between voltages output by the bridge circuits to be zero when servo control on both the generator motor and the motor is turned off.

In the present invention, it is preferable that the two bridge circuits are coupled to each other by a transformer, the phase difference is controlled such that a difference between a voltage value output from the booster and a predetermined threshold equals zero when a K-fold value of voltage output from the storage battery is higher than or equal to the predetermined threshold while the servo control on both the generator motor and the motor is turned off, and K is a boost ratio of the transformer.

### Advantageous Effects of Invention

The present invention can suppress the loss in the booster of the hybrid work machine while the servo control on both the generator motor and the motor is turned off.

### BRIEF DESCRIPTION OF DRAWINGS

FIG. 1 is a perspective view illustrating a hybrid excavator that is an example of a hybrid work machine.

FIG. 2 is a block diagram illustrating a device configuration of the hybrid excavator illustrated in FIG. 1.

FIG. 3 is a diagram illustrating a transformer coupled booster serving as a booster.

FIG. 4 is a diagram provided to describe an operation of the booster.

FIG. 5 is a graph illustrating a relationship between output power and a phase difference of the booster.

FIG. 6 is a diagram illustrating a booster control unit included in a hybrid controller and a booster.

FIG. 7 is a flowchart illustrating a procedure in a method of controlling the hybrid work machine according to the present embodiment.

### DESCRIPTION OF EMBODIMENTS

A mode (an embodiment) of carrying out the present invention will be described in detail with reference to the drawings.

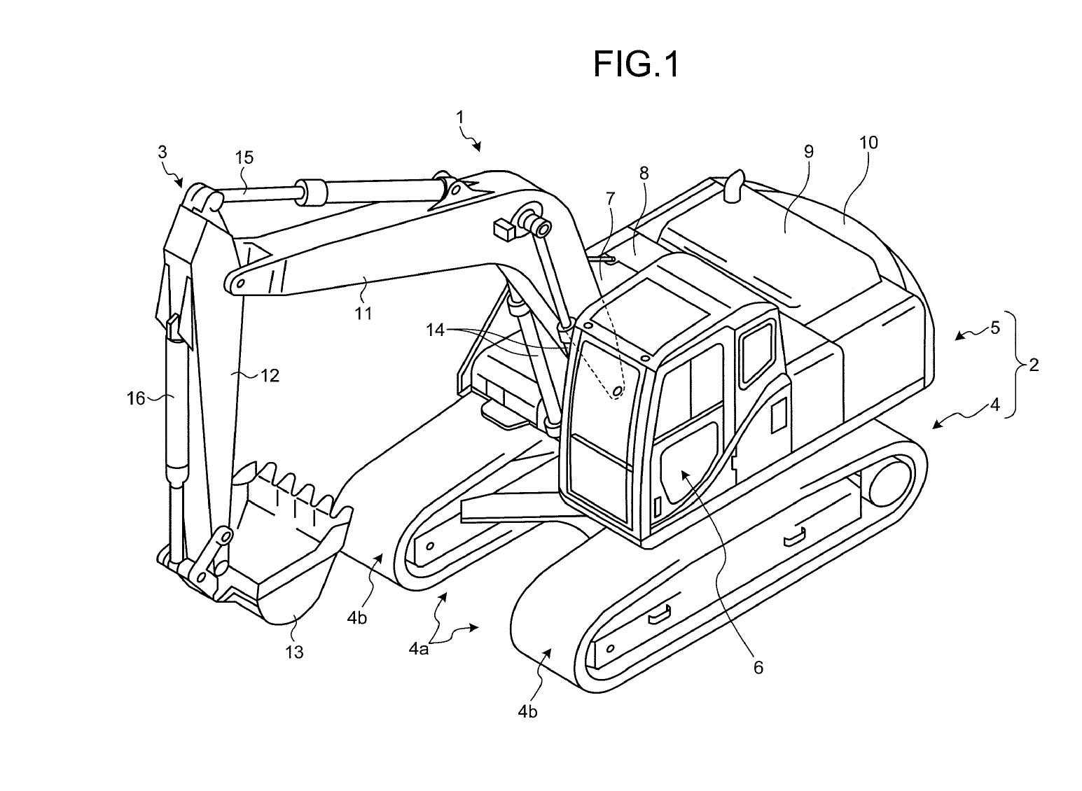

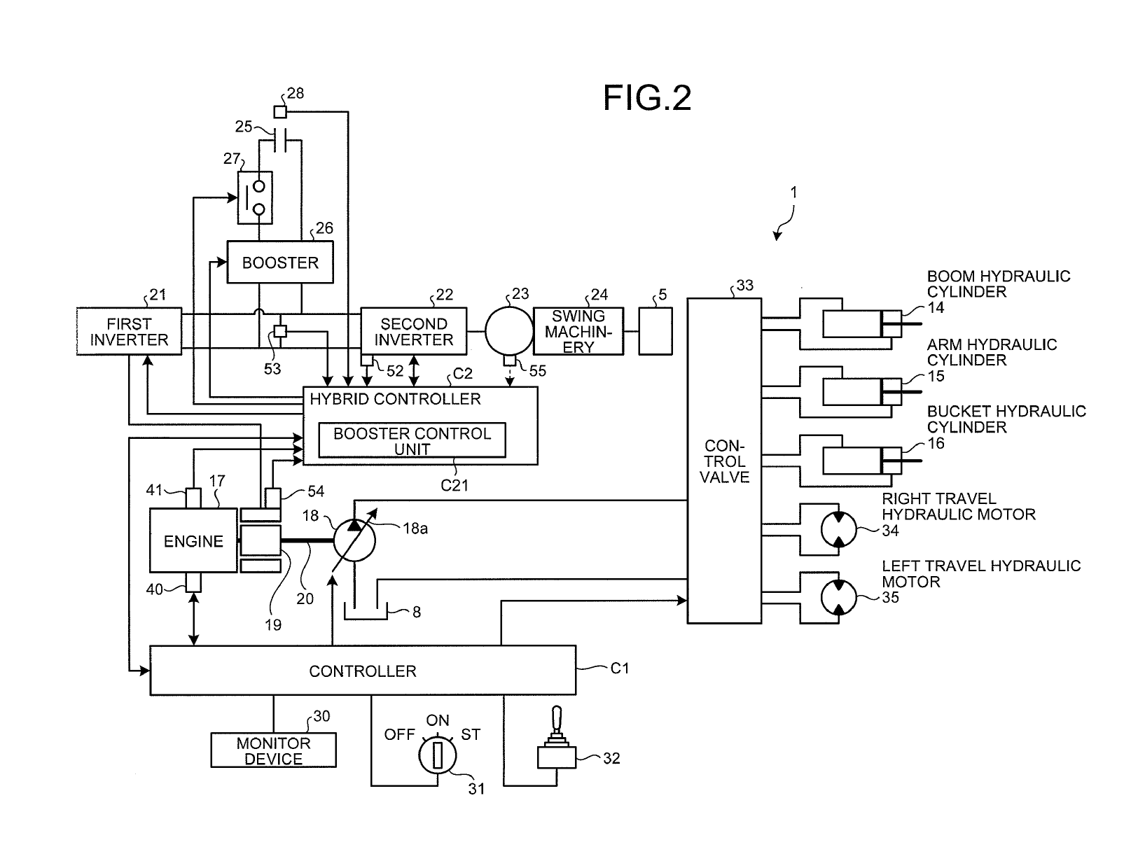

FIG. 1 is a perspective view illustrating a hybrid excavator 1 that is an example of a hybrid work machine. FIG. 2 is a block diagram illustrating a device configuration of the hybrid excavator 1 illustrated in FIG. 1. Note that a non-hybrid, simple work machine includes a construction machine such as an excavator, a bulldozer, a dump truck or a wheel loader, and a construction machine including a configuration specific to a hybrid machine is called the hybrid work machine.

(Hybrid Excavator)

The hybrid excavator 1 serving as the hybrid work machine includes a vehicle body 2 and work equipment 3. The vehicle body 2 includes a lower traveling body 4 and an upper swing body 5. The lower traveling body 4 has a pair of travel units 4a. Each travel unit 4a has a crawler belt 4b. Each travel unit 4a is configured such that the crawler belt 4b is driven by rotation of a right travel hydraulic motor 34 and a left travel hydraulic motor 35 illustrated in FIG. 2 to cause the hybrid excavator 1 to travel.

The upper swing body 5 is provided on top of the lower traveling body 4. The upper swing body 5 swings with respect to the lower traveling body 4. The upper swing body 5, in order for it to swing, includes a swing motor 23 as a motor. The swing motor 23 is connected to a drive shaft of swing machinery 24 (a reduction device). Torque of the swing motor 23 is transmitted through the swing machinery 24, so that the transmitted torque is transmitted to the upper swing body 5 through a swing pinion and a swing circle that are not illustrated to swing the upper swing body 5.

The upper swing body 5 is provided with an operator cab 6. The upper swing body 5 also includes a fuel tank 7, a hydraulic fluid tank 8, an engine room 9, and a counter weight 10. The fuel tank 7 stores fuel used to drive an engine 17 being an internal combustion engine. The hydraulic fluid tank 8 stores hydraulic fluid that is ejected from a hydraulic pump 18 to hydraulic equipment such as a hydraulic cylinder including a boom hydraulic cylinder 14, an arm hydraulic cylinder 15 and a bucket hydraulic cylinder 16 as well as a hydraulic motor (hydraulic actuator) including the right travel hydraulic motor 34 and the left travel hydraulic motor 35. Various equipment including the engine 17, the hydraulic pump 18, a generator motor 19, and a capacitor 25 being a storage battery are stored in the engine room 9. The counter weight 10 is arranged behind the engine room 9.

The work equipment 3 is mounted to the center of a front part of the upper swing body 5 and includes a boom 11, an arm 12, a bucket 13, the boom hydraulic cylinder 14, the arm hydraulic cylinder 15, and the bucket hydraulic cylinder 16. A base end of the boom 11 is swingably connected to the upper swing body 5. A tip end opposite to the base end of the boom 11 is turnably connected to a base end of the arm 12. A tip end opposite to the base end of the arm 12 is turnably connected to the bucket 13. The bucket 13 is connected to the bucket hydraulic cylinder 16 through a link. The boom hydraulic cylinder 14, the arm hydraulic cylinder 15 and the bucket hydraulic cylinder 16 are the hydraulic cylinders (hydraulic actuators) that extend/contract by the hydraulic fluid ejected from the hydraulic pump 18. The boom hydraulic cylinder 14 swings the boom 11. The arm hydraulic cylinder 15 swings the arm 12. The bucket hydraulic cylinder 16 swings the bucket 13.

As illustrated in FIG. 2, the hybrid excavator 1 includes the engine 17 as a driving source, the hydraulic pump 18, and the generator motor 19. A diesel engine is used as the engine 17, while a variable displacement hydraulic pump is used as the hydraulic pump 18. The hydraulic pump 18 is a swash plate hydraulic pump that changes a tilt angle of a swash plate 18a to change the pump capacity, for example, but is not limited to such pump. The engine 17 includes a speed sensor 41 that detects speed (engine speed per unit time) of the engine 17. A signal indicating the speed of the engine 17 (engine speed) detected by the speed sensor 41 is input to a hybrid controller C2. The speed sensor 41 is operated with power from a battery not illustrated, and detects the speed of the engine 17 as long as a key switch 31 to be described is operated to an on (ON) position or a start (ST) position.

The hydraulic pump 18 and the generator motor 19 are mechanically connected to a drive shaft 20 of the engine 17 and are driven when the engine 17 is driven. A hydraulic drive system includes a control valve 33, the boom hydraulic cylinder 14, the arm hydraulic cylinder 15, the bucket hydraulic cylinder 16, the right travel hydraulic motor 34 and the left travel hydraulic motor 35, where these hydraulic equipment are driven when the hydraulic pump 18 supplies the hydraulic fluid to the hydraulic drive system. Note that the control valve 33 is a flow direction control valve that moves a spool (not illustrated) according to an operated direction of a control lever 32, regulates a flow direction of the hydraulic fluid to each hydraulic actuator, and supplies the hydraulic fluid corresponding to an operated amount of the control lever 32 to the hydraulic actuator such as the boom hydraulic cylinder 14, the arm hydraulic cylinder 15, the bucket hydraulic cylinder 16, the right travel hydraulic motor 34 or the left travel hydraulic motor 35. Moreover, output of the engine 17 may be transmitted to the generator motor 19 through a PTO (Power Take Off) shaft.

An electric drive system includes a first inverter 21 connected to the generator motor 19 through a power cable, a second inverter 22 connected to the first inverter 21 through a wiring harness, a booster 26 provided between the first inverter 21 and the second inverter 22 through a wiring harness, the capacitor 25 connected to the booster 26 through a contactor 27 (electromagnetic contactor), and the swing motor 23 connected to the second inverter 22 through a power cable. The contactor 27 normally closes an electric circuit formed of the capacitor 25 and the booster 26 to realize an energized state. On the other hand, the hybrid controller C2 is adapted to determine the need to open the electric circuit by detecting an electric leakage and, when making such determination, the hybrid controller C2 outputs an instruction signal to the contactor 27 to switch the circuit from the energizable state to an interrupted state. The contactor 27 receiving the instruction signal from the hybrid controller C2 then opens the electric circuit.

The swing motor 23 is mechanically connected to the swing machinery 24 as described above. The swing motor 23 is driven by at least one of the power generated in the generator motor 19 and the power stored in the capacitor 25. The swing motor 23 driven by the power supplied from at least one of the generator motor 19 and the capacitor 25 performs a power running operation and swings the upper swing body 5. Moreover, the swing motor 23 performs a regenerative operation when the upper swing body 5 undergoes swing deceleration, and supplies (charges) power (regenerative energy) generated by the regenerative operation to the capacitor 25. Note that the swing motor 23 includes a speed sensor 55 that detects speed of the swing motor 23 (swing motor speed). The speed sensor 55 can measure the speed of the swing motor 23 performing the power running operation (swing acceleration) or the regenerative operation (swing deceleration). A signal indicating the speed measured by the speed sensor 55 is input to the hybrid controller C2. A resolver can be used as the speed sensor 55, for example.

The generator motor 19 supplies (charges) the power generated therein to the capacitor 25 as well as supplies power to the swing motor 23 depending on the situation. The generator motor 19 functions as a motor when the output of the engine 17 is insufficient, thereby assisting the output of the engine 17. An SR (switched reluctance) motor is employed as the generator motor 19, for example. Note that a synchronous motor using a permanent magnet instead of the SR can also be employed to be able to fulfill the role of supplying power to at least one of the capacitor 25 and the swing motor 23. When the SR motor employed as the generator motor 19, the SR motor does not use a magnet containing an expensive rare metal and therefore it is cost effective. A rotor shaft of the generator motor 19 is mechanically connected to the drive shaft 20 of the engine 17. Such structure allows the generator motor 19 to rotate about the rotor shaft thereof by the driving of the engine 17 and generate power. Moreover, a speed sensor 54 is attached to the rotor shaft of the generator motor 19. The speed sensor 54 measures speed of the generator motor 19, and a signal indicating the speed measured by the speed sensor 54 is input to the hybrid controller C2. A resolver can be employed as the speed sensor 54, for example.

The booster 26 is provided between the generator motor 19 as well as the swing motor 23 and the capacitor 25. The booster 26 boosts the voltage of power (electric charge stored in the capacitor 25) supplied to the generator motor 19 or the swing motor 23 through the first inverter 21 or the second inverter 22. The boosted voltage is applied to the swing motor 23 when the swing motor 23 is to undergo the power running operation (swing acceleration) or applied to the generator motor 19 when the output of the engine 17 is to be assisted. The booster 26 also has a role of dropping (stepping down) the voltage when the power generated by the generator motor 19 or the swing motor 23 is charged in the capacitor 25. A booster voltage detection sensor 53 is attached to the wiring harness between the booster 26 and each of the first inverter 21 and the second inverter 22, the booster voltage detection sensor functioning as a voltage detection sensor that measures the voltage boosted by the booster 26 or the voltage of power generated by regeneration of the swing motor 23. A signal indicating the voltage measured by the booster voltage detection sensor 53 is input to the hybrid controller C2.

The booster 26 in the present embodiment has a function of boosting or stepping down input DC power and outputting it as DC power. The type of the booster 26 is not particularly limited as long as the booster has such function. In the present embodiment, for example, a booster called a transformer coupled booster in which a transformer and two inverters are combined is employed as the booster 26. Such booster includes an AC link bidirectional DC-DC converter, for example. The transformer coupled booster will now be described briefly.

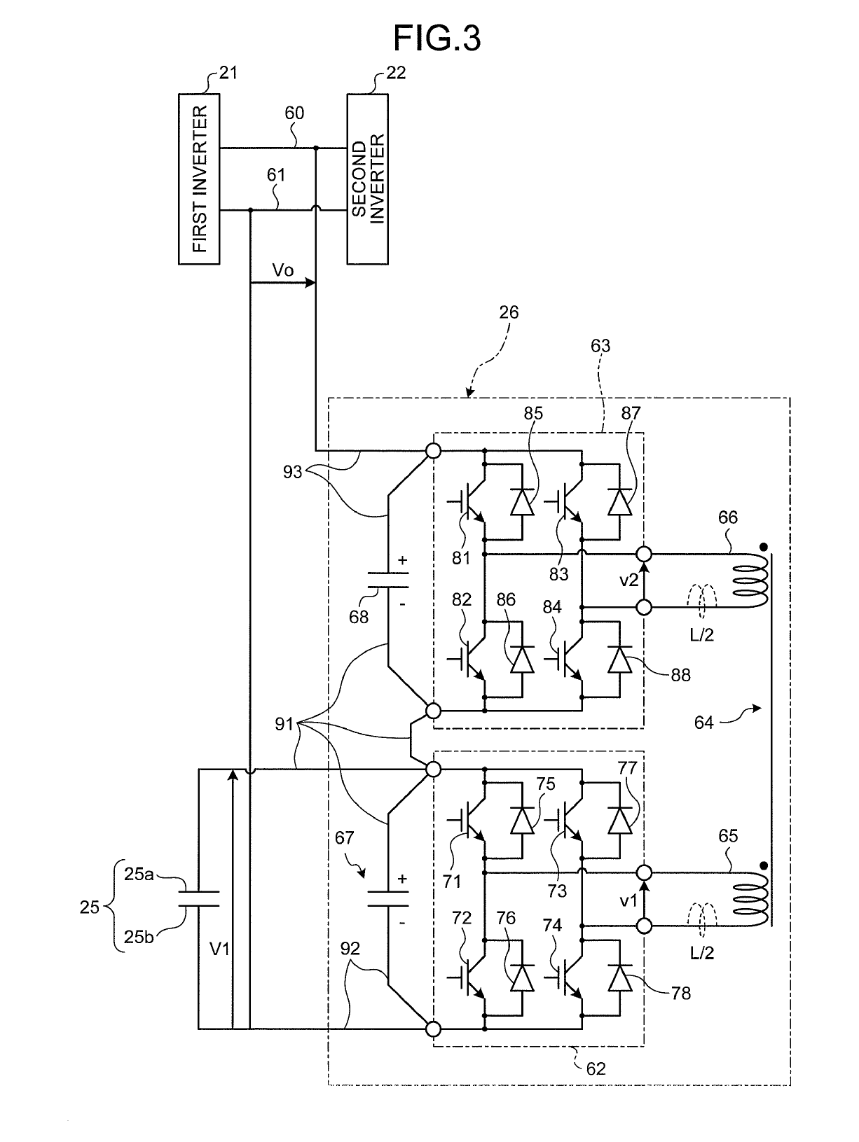

FIG. 3 is a diagram illustrating the transformer coupled booster serving as the booster. As illustrated in FIG. 3, the first inverter 21 and the second inverter 22 are connected through a positive line 60 and a negative line 61 each as a wiring harness. The booster 26 is connected between the positive line 60 and the negative line 61. The booster 26 is configured such that two inverters including a low voltage inverter 62 being a primary inverter and a high voltage inverter 63 being a secondary inverter are AC (Alternating Current) linked and coupled by a transformer 64. Accordingly, the booster 26 is the transformer coupled booster. In the following description, a winding ratio of a low voltage coil 65 to a high voltage coil 66 of the transformer 64 is set one to one.

The low voltage inverter 62 and the high voltage inverter 63 are electrically connected in series such that a positive electrode of the low voltage inverter 62 and a negative electrode of the high voltage inverter 63 have additive polarity. That is, the booster 26 is connected in parallel to have the same polarity as the first inverter 21.

The low voltage inverter 62 is a bridge circuit including IGBTs (Insulated Gate Bipolar Transistors) 71, 72, 73, and 74 as a plurality of switching elements. The low voltage inverter 62 includes the four IGBTs 71, 72, 73, and 74 establishing bridge connection with the low voltage coil 65 of the transformer 64 as well as diodes 75, 76, 77, and 78 that are connected in parallel with the IGBTs 71, 72, 73, and 74 to have reverse polarity therefrom. The bridge connection in this case refers to a structure in which one end of the low voltage coil 65 is connected to an emitter of the IGBT 71 and a collector of the IGBT 72 while another end of the coil is connected to an emitter of the IGBT 73 and a collector of the IGBT 74. The IGBTs 71, 72, 73 and 74 are switched on when a switching signal is applied to a gate, which causes a current to flow from the collector to the emitter.

A positive terminal 25a of the capacitor 25 is electrically connected to a collector of the IGBT 71 through a positive line 91. The emitter of the IGBT 71 is electrically connected to the collector of the IGBT 72. An emitter of the IGBT 72 is electrically connected to a negative terminal 25b of the capacitor 25 through a negative line 92. The negative line 92 is connected to the negative line 61.

Likewise, the positive terminal 25a of the capacitor 25 is electrically connected to a collector of the IGBT 73 through the positive line 91. The emitter of the IGBT 73 is electrically connected to the collector of the IGBT 74. An emitter of the IGBT 74 is electrically connected to the negative terminal 25b of the capacitor 25 through the negative line 92.

The emitter of the IGBT 71 (an anode of the diode 75) and the collector of the IGBT 72 (a cathode of the diode 76) are connected to the one terminal of the low voltage coil 65 of the transformer 64, while the emitter of the IGBT 73 (an anode of the diode 77) and the collector of the IGBT 74 (a cathode of the diode 78) are connected to the other terminal of the low voltage coil 65 of the transformer 64.

The high voltage inverter 63 is a bridge circuit including IGBTs 81, 82, 83, and 84 as a plurality of switching elements. The high voltage inverter 63 includes the four IGBTs 81, 82, 83, and 84 establishing bridge connection with the high voltage coil 66 of the transformer 64 as well as diodes 85, 86, 87, and 88 that are connected in parallel with the IGBTs 81, 82, 83, and 84 to have reverse polarity therefrom. The bridge connection in this case refers to a structure in which one end of the high voltage coil 66 is connected to an emitter of the IGBT 81 and a collector of the IGBT 82 while another end of the coil is connected to an emitter of the IGBT 83 and a collector of the IGBT 84. The IGBTs 81, 82, 83 and 84 are switched on when a switching signal is applied to a gate, which causes a current to flow from the collector to the emitter. The booster 26 includes two bridge circuits, namely the low voltage inverter 62 and the high voltage inverter 63, as described above.

Collectors of the IGBTs 81 and 83 are electrically connected to the positive line 60 of the first inverter 21 through a positive line 93. The emitter of the IGBT 81 is electrically connected to the collector of the IGBT 82. The emitter of the IGBT 83 is electrically connected to the collector of the IGBT 84. Emitters of the IGBTs 82 and 84 are electrically connected to the positive line 91, namely the collectors of the IGBTs 71 and 73 of the low voltage inverter 62.

The emitter of the IGBT 81 (an anode of the diode 85) and the collector of the IGBT 82 (a cathode of the diode 86) are electrically connected to the one terminal of the high voltage coil 66 of the transformer 64, while the emitter of the IGBT 83 (an anode of the diode 87) and the collector of the IGBT 84 (a cathode of the diode 88) are electrically connected to the other terminal of the high voltage coil 66 of the transformer 64.

A capacitor 67 is electrically connected between the positive line 91 to which the collectors of the IGBTs 71 and 73 are connected and the negative line 92 to which the emitters of the IGBTs 72 and 74 are connected. A capacitor 68 is electrically connected between the positive line 93 to which the collectors of the IGBTs 81 and 83 are connected and the positive line 91 to which the emitters of the IGBTs 82 and 84 are connected. The capacitors 67 and 68 are provided to absorb ripple current.

The transformer 64 has leakage inductance of a fixed value L. The leakage inductance can be obtained by adjusting a gap between the low voltage coil 65 and the high voltage coil 66 of the transformer 64. FIG. 3 illustrates a case where the leakage inductance is split between the low voltage coil 65 (L/2) and the high voltage coil 66 (L/2). An operation of the booster 26 will now be described.

(Operation of Booster)

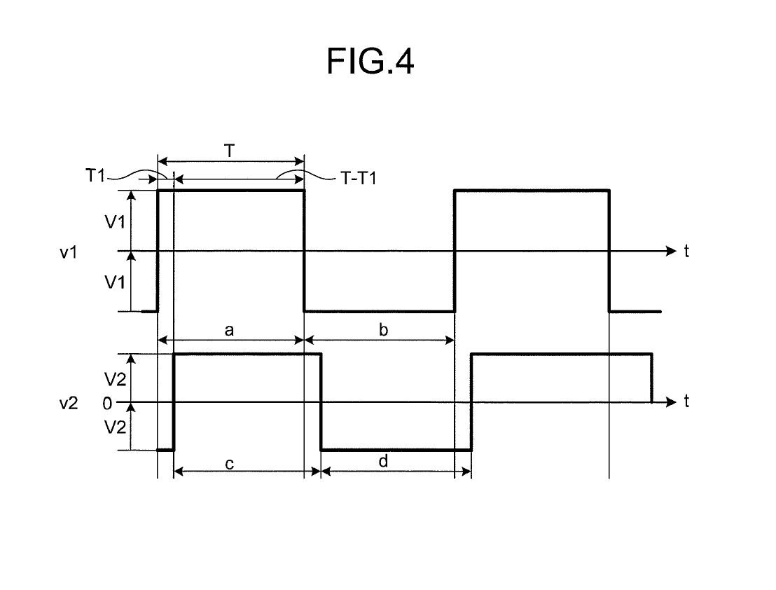

FIG. 4 is a diagram provided to describe the operation of the booster. As illustrated in FIG. 4, voltages (output voltages) v1 and v2 output from the low voltage inverter 62 and the high voltage inverter 63 are square wave voltages with the duty equal to 50%, or a ratio of a high signal to a low signal equal to 1:1. The output voltages v1 and v2 have durations a and c corresponding to the high signal and durations b and d corresponding to the low signal, respectively. For both output voltages v1 and v2, each of the duration of the high signal and the duration of the low signal equals time t=T. The duty thus equals 50%. The output voltages v1 and v2 are square wave voltages each having a period of 2×T.

The booster 26 adjusts the phase difference between the output voltage v1 of the low voltage inverter 62 and the output voltage v2 of the high voltage inverter 63 to adjust power (output power) Po and voltage (output voltage) Vo output from the booster 26. The output voltage of the booster 26 corresponds to the voltage of the electric drive system (system voltage) of the hybrid excavator 1. FIG. 4 illustrates the example where a difference in time t=T1 is generated between the output voltage v1 and the output voltage v2. By using this difference, a phase difference D between the output voltage v1 and the output voltage v2 is expressed by expression (1).

D=T1/T (1)

The output power Po of the booster 26 is expressed by expression (2). In expression (2), Vo denotes the output voltage of the booster 26, V1 denotes voltage of the capacitor 25, ω denotes an angular frequency, and π/T and L denote the leakage inductance of the transformer 64.

Po=π×Vo×V1×(D−D²)/(ω×L) (2)

The generator motor 19 and the swing motor 23 are subjected to torque control by the first inverter 21 and the second inverter 22 under control of the hybrid controller C2. The second inverter 22 is provided with an ammeter 52 that measures a direct current input to the second inverter 22. A signal indicating the current detected by the ammeter 52 is input to the hybrid controller C2. The amount of power (electric charge or capacitance) stored in the capacitor 25 can be managed with the magnitude of voltage as an index. In order to detect the magnitude of voltage of the power stored in the capacitor 25, a storage battery voltage sensor 28 is provided to a predetermined output terminal of the capacitor 25. A signal indicating the voltage detected by the storage battery voltage sensor 28 is input to the hybrid controller C2. The hybrid controller C2 monitors the amount of charge (amount of power (electric charge or capacitance)) of the capacitor 25 and performs energy management that determines whether to supply (charge) the power generated by the generator motor 19 to the capacitor 25 or to the swing motor 23 (power supplied for power running action). The hybrid controller C2, more specifically the booster control unit C21 adjusts the phase difference between the output voltage v1 of the low voltage inverter 62 and the output voltage v2 of the high voltage inverter 63 included in the booster 26 such that the output voltage Vo of the booster 26 equals a predetermined voltage.

The capacitor 25 stores at least the power generated by the generator motor 19 as described above. The capacitor 25 further stores the power generated by the regenerative operation of the swing motor 23 when the upper swing body 5 undergoes swing deceleration. In the present embodiment, an electric double layer capacitor is employed as the capacitor 25, for example. Another storage battery functioning as a secondary battery such as a lithium ion battery or a nickel-metal hydride battery may be employed instead of the capacitor 25. Moreover, the swing motor 23 is not limited to the permanent magnet synchronous motor employed in this example.

The hydraulic drive system and the electric drive system are driven in accordance with an operation of the control lever 32 such as a work equipment lever, a travel lever, and a swing lever provided inside the operator cab 6 of the vehicle body 2. When an operator of the hybrid excavator 1 operates the control lever 32 (swing lever) functioning as an operation unit to swing the upper swing body 5, an operated direction and an operated amount of the swing lever are detected by a potentiometer or a pilot pressure sensor so that the detected operated amount is transmitted as an electric signal to the controller C1 and the hybrid controller C2.

Likewise, an electric signal is transmitted to the controller C1 and the hybrid controller C2 when another type of the control lever 32 is operated. In response to the operated direction and operated amount of the swing lever or the operated direction and operated amount of the other control lever 32, the controller C1 and the hybrid controller C2 control the second inverter 22, the booster 26 and the first inverter 21 in order to control transferring of power (perform energy management) such as a rotational operation (power running action or regenerative action) of the swing motor 23, management of electric energy (charge or discharge control) of the capacitor 25, and management of electric energy (power generation, assisting engine output, or power running action on the swing motor 23) of the generator motor 19.

In addition to the control lever 32, a monitor device 30 and the key switch 31 are provided inside the operator cab 6. The monitor device 30 is formed of a liquid crystal panel, an operation button and the like. The monitor device 30 may also be a touch panel on which a display function of the liquid crystal panel and a various information input function of the operation button are integrated. The monitor device 30 is an information input/output device which has a function of notifying the operator or a service man of information indicating an operating state (state concerning engine water temperature, presence/absence of trouble with the hydraulic equipment, or an amount of fuel remaining) of the hybrid excavator 1, as well as a function of performing setting or providing an instruction (output level setting for the engine, speed level setting for the traveling speed, or a capacitor charge release instruction to be described) desired by the operator against the hybrid excavator 1.

The key switch 31 is formed of a key cylinder as a main component. The key switch 31 is configured such that a key is inserted to a key cylinder and turned to start a starter (engine starting motor) attached to the engine 17 and drive the engine 17 (engine start). Moreover, the key switch 31 is configured to give a command to stop the engine (engine stop) by turning the key in a direction opposite to that in which the key is turned at the time of the engine start while the engine is running. The key switch 31 is a so-called command output unit that outputs a command to the engine 17 and various electric equipment of the hybrid excavator 1.

When the key is subjected to the turn operation (specifically, operated to an off position to be described) to stop the engine 17, fuel supply to the engine 17 as well as supply of electricity (energization) from a battery not illustrated to various electric equipment are cut off, thereby stopping the engine. The key switch 31 can cut off energization from the battery not illustrated to the various electric equipment when the key subjected to the turn operation is turned to the off position (OFF), perform energization from the battery not illustrated to the various electric equipment when the key is turned to an on position (ON), and start the engine by starting the starter not illustrated through the controller C1 when the key is further subjected to a turn operation and turned from the on position to a start position (ST). After the engine 17 is started, the turned position of the key is at the on position (ON) while the engine 17 runs.

Note that the key switch 31 formed of the aforementioned key cylinder as the main component may instead be another command output unit such as a key switch of a push button type. That is, the key switch may be one that functions to turn on (ON) the engine when a button is pressed once while the engine 17 is stopped, start (ST) the engine when the button is pressed again, and turn off (OFF) the engine when the button is pressed while the engine 17 runs. The key switch may also be adapted to be able to shift the states from off (OFF) to start (ST) and start the engine 17 on condition that the button is kept pressed for a predetermined duration while the engine 17 is stopped.

The controller C1 is formed of a combination of an arithmetic unit such as a CPU (Central Processing Unit) and a memory (storage). The controller C1 controls the engine 17 and the hydraulic pump 18 on the basis of an instruction signal output from the monitor device 30, an instruction signal output in accordance with the key position of the key switch 31, and an instruction signal (signal indicating the aforementioned operated amount and operated direction) output in accordance with the operation of the control lever 32. The engine 17 is an engine that can be electronically controlled by a common-rail fuel injection device 40. The engine 17 can achieve target engine output when a fuel injection amount is properly controlled by the controller C1, and can run while the engine speed and torque that can be output are set according to a load state of the hybrid excavator 1.

The hybrid controller C2 is formed of a combination of an arithmetic unit such as a CPU and a memory (storage). Under cooperative control with the controller C1, the hybrid controller C2 controls the first inverter 21, the second inverter 22 and the booster 26 as described above and controls transferring of power with respect to the generator motor 19, the swing motor 23 and the capacitor 25. The hybrid controller C2 further acquires a detection value detected by various sensors such as the storage battery voltage sensor 28 and controls the hybrid excavator 1 on the basis of the detection value.

The hybrid controller C2 includes the booster control unit C21. The aforementioned CPU or the like implements a function of the booster control unit C21. Next, there will be described in more detail the control performed on the output voltage of the booster 26 by the booster control unit C21 of the hybrid controller C2.

(Controlling Output Voltage Of Booster)

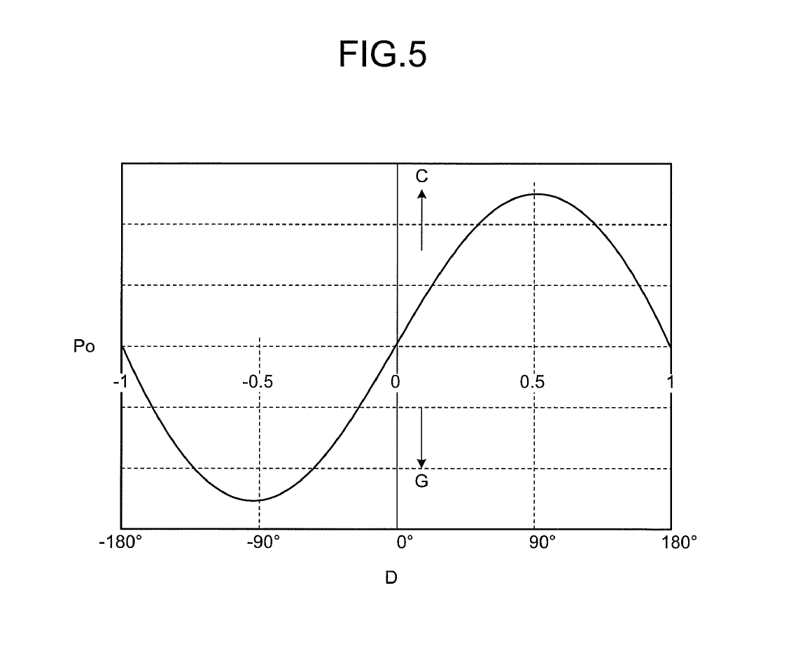

FIG. 5 is a graph illustrating a relationship between the output power and phase difference of the booster. As illustrated in FIG. 5, the output power Po of the booster 26 at the time of power running (a side corresponding to an arrow C) increases as a phase difference D increases when the phase difference D is from 0° to 90°, and decreases as the phase difference D increases when the phase difference D is from 90° to 180°. The output power Po of the booster 26 at the time of regenerating (a side corresponding to an arrow G) increases as the phase difference D increases when the phase difference D is from −90° to 0°, and decreases as the phase difference D increases when the phase difference D is from −180° to −90°. The booster control unit C21 of the hybrid controller C2 controls the booster 26 to operate within the range of the phase difference D that is −90° or larger and 90° or smaller when at least the generator motor 19 is in a power generating state or the swing motor 23 is in an operated state.

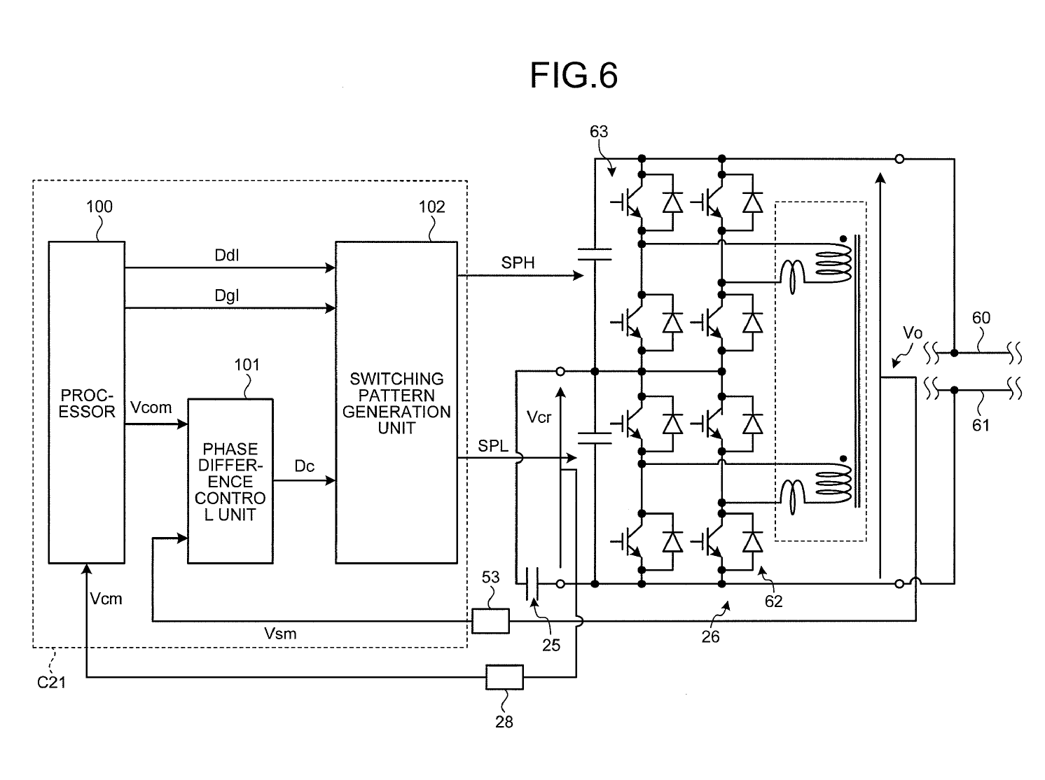

FIG. 6 is a diagram illustrating the booster control unit included in the hybrid controller and the booster. The booster control unit C21 included in the hybrid controller C2 illustrated in FIG. 2 includes a processor 100, a phase difference control unit 101, and a switching pattern generation unit 102. Output from the storage battery voltage sensor 28 is input to the processor 100. The output from the storage battery voltage sensor 28 is a voltage (capacitor voltage detected value) Vcm of the capacitor 25 detected by the storage battery voltage sensor 28. The capacitor voltage detected value Vcm corresponds to an inter-terminal voltage (capacitor voltage) Vcr (true value) of the capacitor 25.

Output from the booster voltage detection sensor 53 is input to the phase difference control unit 101. The output from the booster voltage detection sensor 53 is an output voltage (booster voltage detected value) Vsm of the booster 26 detected by the booster voltage detection sensor 53. The booster voltage detected value Vsm corresponds to the output voltage Vo (true value) of the booster 26. The output voltage Vo of the booster 26 is a voltage across the positive line 60 and the negative line 61 and is the output voltage or input voltage of the first inverter 21 and the second inverter 22 illustrated in FIGS. 2 and 3.

The booster control unit C21 of the hybrid controller C2 outputs a command value Vcom of the voltage output by the booster 26 to the phase difference control unit 101 such that the voltage output by the booster 26 equals a predetermined value. Moreover, the processor 100 outputs to the switching pattern generation unit 102 a limit value Dd1 of the phase difference D at the time of power running and a limit value Dg1 of the phase difference D at the time of regenerating. The former equals +90°, and the latter equals −90°. The switching pattern generation unit 102 controls the low voltage inverter 62 and the high voltage inverter 63 of the booster such that the phase difference D of the booster 26 does not exceed the limit values Dd1 and Dg1.

The phase difference control unit 101 obtains the phase difference D of the booster 26 such that a difference between the command value Vcom and the booster voltage detected value Vsm equals zero, and outputs the obtained phase difference D as a phase difference command value Dc to the switching pattern generation unit 102. The switching pattern generation unit 102 generates switching patterns SPL and SPH to turn ON/OFF each switching element included in the low voltage inverter 62 and the high voltage inverter 63, respectively. The switching pattern generation unit 102 supplies, to the low voltage inverter 62 and the high voltage inverter 63, the switching patterns SPL and SPH generated to have the phase difference D of the booster 26 equal to the phase difference command value Dc, and turns ON/OFF the switching element included in the corresponding inverters. That is, the switching pattern generation unit 102 is driven such that the phase difference of the booster 26 equals the phase difference command value Dc. As a result, the output voltage Vo of the booster 26 equals the command value Vcom output from the processor 100. The booster control unit C21 as has been described performs feedback control on the booster 26 such that the output voltage Vo of the booster equals the predetermined value (the command value Vcom in this example).

The booster control unit C21 performs the aforementioned control at the time of power running (when the swing motor 23 generates motive power) or regenerating (when the swing motor 23 generates electric power). Next, control performed by the booster control unit C21 during standby will be described. The standby corresponds to the time when the generator motor 19 does not generate power or perform power running and at the same time the swing motor 23 is stopped. In other words, the standby corresponds to the time when the servo control on both the generator motor and the motor is turned off. Note that, during standby, a swing parking brake (not illustrated) provided to the swing machinery 24 is activated to prevent the upper swing body 5 from swinging accidentally. During standby, the booster control unit C21 controls the phase difference between the output voltage v1 of the low voltage inverter 62 and the output voltage v2 of the high voltage inverter 63 to be zero. In the present embodiment, the processor 100 of the booster control unit C21 outputs to the switching pattern generation unit 102 the limit values Dd1 and Dg1 while setting them to 0°. The switching pattern generation unit 102 generates the switching patterns SPL and SPH such that the phase difference command value equals Dc=0° and supplies the patterns to the low voltage inverter 62 and the high voltage inverter 63 of the booster 26. As a result, the low voltage inverter 62 and the high voltage inverter 63 are driven such that the phase difference D of the booster 26 equals the phase difference command value Dc, namely 0°.

The booster 26 has the minimum loss when operated with a boost ratio K that is determined by the winding ratio of the low voltage coil 65 to the high voltage coil 66 of the transformer 64 illustrated in FIG. 3. The boost ratio K can be obtained by expression (3). In expression (3), N1 denotes the number of turns of the low voltage coil 65, and N2 denotes the number of turns of the high voltage coil 66. While the boost ratio equals K=2 since N1=N2 in the present embodiment, N1, N2, and K are not limited to these values.

K=(N1+N2)/N1 (3)

As a variation of the control performed during standby, there is a method in which the booster control unit C21 controls the booster 26 such that the booster 26 has the output voltage Vo with which the booster 26 has the minimum loss. The output voltage Vo of the booster 26 with which the booster 26 has the minimum loss equals a capacitor voltage Vcr×K. In the variation, the processor 100 outputs Vcr×K as the command value Vcom to the phase difference control unit 101. The capacitor voltage Vcr is practically a capacitor voltage detected value Vcm that is detected by the storage battery voltage sensor 28 and is input to the processor 100. Accordingly, the processor 100 outputs Vcm×K as the command value Vcom to the phase difference control unit 101. This allows the booster 26 to operate with the boost ratio K, thereby resulting in the minimum loss.

In the variation, when there is an error with a detected value of the storage battery voltage sensor 28, namely the capacitor voltage detected value Vcm, a corresponding deviation occurs in the command value Vcom. While feedback control on the booster 26 is performed to set the difference between the command value Vcom and the booster voltage detected value Vsm to be zero, there is a possibility that the booster voltage detected value Vsm detected by the booster voltage detection sensor 53 has an error. It is therefore highly likely that a deviation occurs in the output voltage Vo of the booster 26 when the booster 26 is subjected to the feedback control with use of the aforementioned command value Vcom and booster voltage detected value Vsm. When a loss is generated in the booster 26 during standby, power of the capacitor 25 is consumed and thus the capacitor voltage Vcr is decreased. The loss in the booster 26 varies according to the deviation of the output voltage Vo of the booster 26, whereby a variation occurs in the speed of decrease of the capacitor voltage Vcr during standby.

During standby, the hybrid controller C2 causes the generator motor 19 to generate power and charges the capacitor 25 when the capacitor voltage Vcr (the capacitor voltage detected value Vcm in the control) drops below a predetermined value. The engine 17 is made to exert work in order to cause the generator motor 19 to generate power, so that the fuel is consumed for the work exerted by the engine 17 to charge the capacitor 25. The error with the capacitor voltage detected value Vcm and the booster voltage detected value Vsm possibly occurs between the hybrid excavators 1 of the same kind. That is, in the variation, the fuel consumption during standby possibly varies between the hybrid excavators 1 of the same kind.

In the present embodiment, as described above, the booster control unit C21 drives the low voltage inverter 62 and the high voltage inverter 63 such that the phase difference D of the booster 26 equals 0°. Accordingly, the output voltage Vo (true value) of the booster 26 corresponds to a K-fold value of the capacitor voltage Vcr (true value), namely a value with which the booster 26 has the minimum loss, regardless of the variation in the capacitor voltage detected value Vcm and the booster voltage detected value Vsm. As a result, the booster 26 has the minimum loss regardless of the variation in the capacitor voltage detected value Vcm and the booster voltage detected value Vsm. The present embodiment is thus adapted to be able to suppress the loss in the booster 26 while the generator motor 19 does not generate power and at the same time the swing motor 23 is stopped, or while these motors are on standby. The present embodiment is adapted to be able to suppress the loss in the booster 26 during standby even when the variation occurs in the capacitor voltage detected value Vcm or the booster voltage detected value Vsm due to aging of the storage battery voltage sensor 28 or the booster voltage detection sensor 53, for example. The present embodiment is particularly effective in preventing the variation of the fuel consumption during standby between the hybrid excavators 1 of the same kind.

In the present embodiment, when the capacitor voltage Vcr (the capacitor voltage detected value Vcm in the control) equals a predetermined threshold Vcri or higher during standby, the booster control unit C21 controls the phase difference D such that a difference between a K-fold value of the predetermined threshold Vcri and the output voltage Vo (the booster voltage detected value Vsm in the control) of the booster 26 equals zero. The predetermined threshold Vcri is determined such that the K-fold value of the threshold becomes a rated voltage of the electric drive system (rated value of the system voltage) of the hybrid excavator 1, for example. The rated voltage of the electric drive system is determined on the basis of a withstand voltage or like of an electronic component included in the electric drive system such as the first inverter 21 and the second inverter 22.

The booster control unit C21 controls the booster 26 to obtain K×Vcri−Vo(Vsm)=0 when Vcr(Vcm)≧Vcri. The output voltage Vo of the booster 26 thus becomes lower than or equal to the rated voltage, namely K×Vcri, of the electric drive system of the hybrid excavator 1 so that the electronic component or the like included in the electric drive system is used within the withstand voltage thereof. As a result, there can be prevented the degradation in durability of the electronic component or the like included in the electric drive system. Next, a procedure in the method of controlling the hybrid work machine according to the present embodiment will be described briefly.

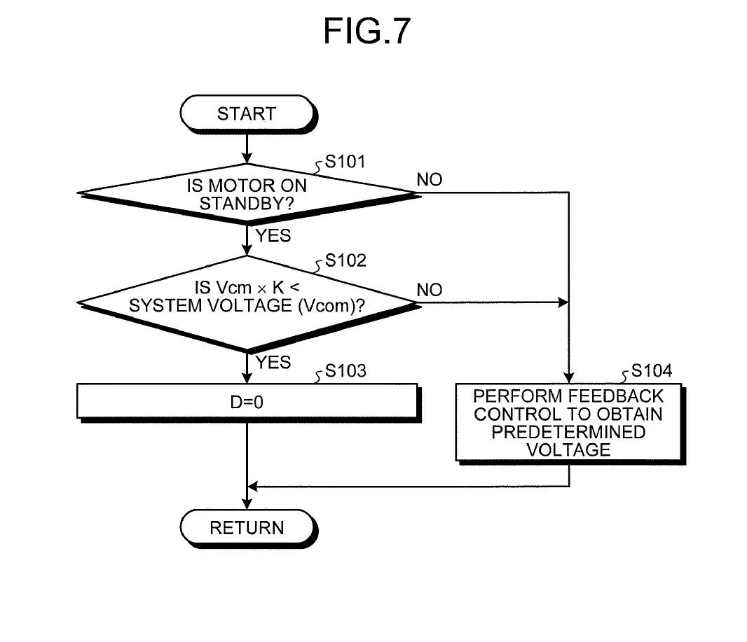

FIG. 7 is a flowchart illustrating the procedure in the method of controlling the hybrid work machine according to the present embodiment. In the execution of the method of controlling the hybrid work machine according to the present embodiment, the booster control unit C21 determines the state of each of the generator motor 19 and the swing motor 23 in step S101. It can be determined whether or not the generator motor 19 and the swing motor 23 are on standby on the basis of a state of control performed on these motors by the hybrid controller C2 illustrated in FIG. 2, for example. The generator motor 19 and the swing motor 23 are on standby when, for example, the hybrid controller C2 controls the generator motor 19 to have zero power generation and not perform power running, and further controls the swing motor 23 to receive zero speed command, namely when servo control on both the generator motor 19 and the swing motor 23 is stopped.

When the generator motor 19 and the swing motor 23 are on standby (Yes in step S101), the booster control unit C21 in step S102 acquires the capacitor voltage detected value Vcm from the storage battery voltage sensor 28 and compares the K-fold value of Vcm with the rated value (Vcom) of the system voltage being the predetermined threshold. When Vcm×K<Vcom (Yes in step S102), the booster control unit C21 in step S103 controls the booster 26 such that the phase difference D equals zero. Specifically, as described above, the processor 100 of the booster control unit C21 outputs to the switching pattern generation unit 102 the limit values Dd1 and Dg1 while setting them to 0°. This allows the low voltage inverter 62 and the high voltage inverter 63 to be driven such that the phase difference D of the booster 26 equals 0°, whereby the output voltage Vo (true value) of the booster 26 equals the K-fold value of the capacitor voltage Vcr (true value), or the value with which the booster 26 has the minimum loss. As a result, the loss of the booster 26 is minimized during standby.

When Vcm×K≧Vcom (No in step S102), the booster control unit C21 in step S104 performs feedback control on the booster 26 such that the booster 26 has the predetermined voltage. The predetermined voltage at this time is the rated value of the rated voltage (Vcom, the predetermined threshold) described above, for example. At least one of the generator motor 19 and the swing motor 23 is in operation when the generator motor 19 and the swing motor 23 are not on standby (No in step S101). In other words, the servo control on at least one of the generator motor 19 and the swing motor 23 is turned on. In this case, the booster control unit C21 in step S104 performs feedback control on the booster 26 such that the booster 26 has the predetermined voltage (such as the rated value of the rated voltage).

The present embodiment is not to be limited to what has been described above. It has been described in the present embodiment that the hybrid excavator 1 includes the swing motor 23 being the motor that makes the upper swing body 5 perform swing acceleration (power running) and swing deceleration (regeneration). However, the hybrid excavator 1 may instead include the swing motor 23 and the hydraulic motor that are integrated. That is, it may be adapted such that the hydraulic motor assists the rotation of the swing motor 23 when the upper swing body 5 of the hybrid excavator 1 is subjected to swing acceleration.

The components in the aforementioned embodiment include one that is easily conceivable by those skilled in the art and one that is substantially identical, or so-called what falls within the range of equivalence. The aforementioned components can also be combined as appropriate. Moreover, the components can be subjected to various omissions, substitutions and modifications without departing from the scope of the present embodiment. Furthermore, the motor is not limited to the swing motor that swings the upper swing body of the hybrid excavator.

### REFERENCE SIGNS LIST

1 hybrid excavator

5 upper swing body

17 engine

19 generator motor

20 drive shaft

21 first inverter

22 second inverter

23 swing motor

25 capacitor

25a positive terminal

25b negative terminal

26 booster

27 contactor

28 storage battery voltage sensor

52 ammeter

53 booster voltage detection sensor

60, 91, 93 positive line

61, 92 negative line

62 low voltage inverter

63 high voltage inverter

64 transformer

65 low voltage coil

66 high voltage coil

67, 68 capacitor

71 to 74, 81 to 84 IGBT

75 to 78, 85 to 88 diode

100 processor

101 phase difference control unit

102 switching pattern generation unit

C1 controller

C2 hybrid controller

C21 booster control unit

D phase difference

K boost ratio

1. A hybrid work machine comprising:
a generator motor that is connected to a drive shaft of an internal combustion engine;
a storage battery that stores at least power generated by the generator motor;
a motor that is driven by at least one of the power generated by the generator motor and power stored in the storage battery;
a booster that includes two bridge circuits each having a plurality of switching elements and is provided between the generator motor as well as the motor and the storage battery; and
a booster control unit that sets a phase difference between voltages output by the bridge circuits to be zero during standby in which servo control on both the generator motor and the motor is turned off.

2. The hybrid work machine according to claim 1, wherein
the two bridge circuits are coupled to each other by a transformer,
the booster control unit controls the phase difference such that a difference between a voltage value output from the booster and a predetermined threshold equals zero when a K-fold value of voltage output from the storage battery is higher than or equal to the predetermined threshold during the standby, and
K is a boost ratio of the transformer.

3. A hybrid work machine comprising:
a generator motor that is connected to an output shaft of an internal combustion engine;
a storage battery that stores power generated by the generator motor;
a motor that is driven by at least one of the power generated by the generator motor and power stored in the storage battery;
a booster that is a transformer coupled DC-DC converter in which two bridge circuits each having a plurality of switching elements are coupled to each other by the transformer, and is provided between the generator motor as well as the motor and the storage battery; and
a booster control unit that sets a phase difference between voltages output by the bridge circuits to be zero during standby in which servo control on both the generator motor and the motor is turned off, and controls the phase difference such that a difference between a voltage value output from the booster and a predetermined threshold equals zero when a K-fold value of voltage output from the storage battery is higher than or equal to the predetermined threshold during the standby, wherein
K is a boost ratio of the transformer coupling the two bridge circuits included in the booster.

4. A method of controlling a hybrid work machine including a generator motor that is connected to a drive shaft of an internal combustion engine, a storage battery that stores at least power generated by the generator motor, a motor that is driven by at least one of the power generated by the generator motor and power stored in the storage battery, and a booster that includes two bridge circuits each having a plurality of switching elements and is provided between the generator motor as well as the motor and the storage battery, the method comprising:
determining a state of the generator motor and the motor; and
setting a phase difference between voltages output by the bridge circuits to be zero when servo control on both the generator motor and the motor is turned off.

5. The method of controlling a hybrid work machine according to claim 4, wherein
the two bridge circuits are coupled to each other by a transformer,
the phase difference is controlled such that a difference between a voltage value output from the booster and a predetermined threshold equals zero when a K-fold value of voltage output from the storage battery is higher than or equal to the predetermined threshold while the servo control on both the generator motor and the motor is turned off, and
K is a boost ratio of the transformer.
